(19) United States
(12) Patent Application Publication
(10) Pub. No.: US 2014/0260438 A1
(43) Pub. Date: Sep. 18, 2014

(54) LEATHER-PUNCHING DEVICE, LEATHER-PUNCHING METHOD AND LEATHER SHEET

(71) Applicant: MIDORI HOKUYO CO., LTD., Yamagata-shi, Yamahata (JP)

(72) Inventor: Kensaku Matsumura, Yamagata-shi (JP)

(21) Appl. No.: 14/354,315

(22) PCT Filed: Nov. 5, 2012
(86) PCT No.: PCT/JP2012/078596

§ 371 Date: Apr. 25, 2014

(30) Foreign Application Priority Data
Nov. 7, 2011 (JP) 2011 -243521

(51) Int. Cl. C14B 5/00; B26F 1/14

(52) U.S. Cl. CPC C14B 5/00; B26F 1/14
USPC 69/2; 69/21; 428/131

(57) ABSTRACT

A leather punching device 1 has a receiving mold 21 formed with receiving holes 22, a pressing mold 31 formed with storing holes 32 which communicate with the receiving holes 22 when joined with the receiving mold 21, and a moving member 45 provided with punching pins 5 which are stored in the storing holes 32 of the pressing mold 31, pressing projections 35 are provided around the storing hole 32 of the pressing mold 31, a leather 3 is disposed between the receiving mold 21 and the pressing mold 31, the pressing projections 35 of the pressing mold 31 come into pressure-contact with the leather 3, and the punching pins 5 project from the pressing projections 35 by the movement of the moving member 45 to one side to form punch holes 9 in the leather 3.

### TECHNICAL FIELD

The present invention relates to a leather punching device and leather punching method for forming punch holes in a leather to form a leather sheet, and a leather sheet in which punch holes are formed.

### BACKGROUND ART

Conventionally, a plurality of holes has been opened in leather products to secure breathability. A process of opening the plurality of holes is said to be a perforation process. The leather products processed in this manner are mainly used in automotive interior products, and products of furniture. The holes have a size of about 0.5 to 1.7 mm and the plurality of holes is provided in the leather products at regular intervals.

Conventionally, as illustrated in FIGS. 9 to 13, a leather punching device 1 configured to form punch holes in a leather 3 has a base 2, a pressing device 10, a receiving mold 21 that is provided on the base 2 and formed with a plurality of receiving holes 22, and a punching device 30 provided on the pressing device 10. The punching device 30 has a pressing mold 31 which can be joined with the receiving mold 21 and is formed with a plurality of storing holes 32 each communicating with the plurality of receiving holes 22 when joined with the receiving mold 21, a moving member 45 provided with a plurality of punching pins 5 stored in the plurality of storing holes 32 of the pressing mold 31, and an elastic member 52 that is provided between the pressing mold 31 and the moving member 45 and urges the pressing mold 31 and the moving member 45 in directions away from each other and stores the punching pins 5 within the storing holes 32 (For example, Patent document 1).

The leather punching device 1 is configured so that, as illustrated in FIG. 11, when the moving member 45 moves to one side (downward) against elasticity of the elastic member 52, the plurality of punching pins 5 projects from the pressing mold 31, and as illustrated in FIG. 12, when the moving member 45 moves to the other side (upward) due to elasticity of the elastic member 52, the plurality of punching pins 5 is retracted into the storing holes 32 of the pressing mold 31. In the leather punching device 1, as illustrated in FIG. 9, when the leather 3 is disposed between the pressing mold 31 and the receiving mold 21 and the punching device 30 is pressed in a direction of the receiving mold 21 by the pressing device 10, as illustrated in FIG. 10, the pressing mold 31 comes into pressure-contact with the leather 3 on the receiving mold 21, as illustrated in FIG. 11, the moving member 45 moves to one side (downward) against elasticity of the elastic member 52, and the plurality of punching pins 5 projects from the pressing mold 31 to form a plurality of punch holes 9 in the leather 3.

### PRIOR ART DOCUMENT

### Patent Document

Patent document 1: JP 2010-115718 A

### SUMMARY OF THE INVENTION

### Problem to be Solved by the Invention

As illustrated in FIG. 11, when punching the punching pins 5, the conventional leather punching device 1 has pressed the leather 3 while holding the leather by receiving mold 21 and the pressing mold 31, but in some cases, the leather 3 has been punched with the periphery of the punching position being wound to the inside lower part, and a front surface side of a grain side layer 3A (in the case of a split leather having no grain side layer 3A, a front surface side of a reticular layer 3B) has extended to the inside lower part. Furthermore, as illustrated in FIG. 12, the conventional leather punching device 1 has pulled out the punching pins 5 while winding the leather 3 on the periphery of the punching position to the inside upper part by frictional resistance of the punching pins 5 and the leather 3, and has also extended the front surface side of the grain side layer 3A (in the case of a split leather having no grain side layer 3A, a front surface side of the reticular layer 3B) to the inside upper part. Thus, there has been a problem in that the conventional leather punching device 1 sometimes impairs the shape of the punch holes 9. Furthermore, since the reticular layer 3B of the leather 3 is a fiber layer, when pulling out the punching pins 5, as illustrated FIGS. 13, 16 and 17, a fiber 3G has jumped out (fluffed) to the inside of the punch holes 9 by the frictional resistance, thereby blocking the punch hole 9. The leather products have been used to cover seats of a car, a steering wheel, and furniture, and have been used for luxury cars, luxury sofas due to the texture thereof, but there has been a problem in that when the shape of the punch holes 9 is impaired or the punch holes 9 are blocked by fluffing, high-grade sense is impaired and the commercial value is lowered.

As illustrated in FIG. 13, the conventional punch holes 9 are formed through a back surface from a front surface of the leather 3. The leather 3 includes the grain side layer 3A on the front surface side and the reticular layer 3B on an inner surface side, and on the grain side layer 3A of the front surface side, in order to provide protection, beauty, and a function mainly to the front surface, a paint is applied to the front surface to form a coating film 3F (see FIG. 7). Furthermore, the leather 3 is a so-called split leather made up of only the reticular layer 3B, and there is also a leather in which the paint is applied to the front surface of the reticular layer 3B to form the coating film 3F. There is a possibility that the coating film 3F is separated from the grain side layer 3A or the reticular layer 3B, and when the cross-section thereof is exposed, since the coating film 3F may be peeled off from the grain side layer 3A or the reticular layer 3B in the cross-section portion, it is desirable to prevent the cross-section from being exposed. Thus, since the cross-section is exposed, end edges of the leather 3 are sewn to be folded inwardly. However, since the punch holes 9 are formed through the back surface from the front surface of the leather 3, the cross-section is exposed to the inside of the punch holes 9 and is present on the front surface of the leather 3. Thus, finger nails and the like are easily caught by the peripheries of the punch holes 9. For that reason, there has been a problem in that the coating film 3F easily peels off from the peripheries of the punch holes 9. In the conventional leather 3, since the peripheries (end edges) of the punch holes 9 are at the same position as the front surface of the leather 3, there has been a problem in that the finger nails and the like are easily caught by the peripheries (end edges) of the punch holes 9, and the coating film 3F is easily peeled off.

The invention was devised in view of the above-described problems, and a first object thereof is to provide a leather punching device that forms a leather sheet in which fluffing in punch holes is very small without impairing the shape of the punch holes, by punching the leather with the periphery of the punching position in a fixed state.

Furthermore, a second object thereof is to provide a leather punching method of forming a leather sheet in which fluffing in punch holes is very small without impairing the shape of the punch holes by punching the leather with the periphery of the punching position in a fixed state. Furthermore, a third object thereof is to provide a leather sheet in which punch holes are located at a position recessed from the front surface and nails and the like are hardly caught by the peripheries of the punch holes, by forming recess parts on the front surface of the leather and forming the punch holes in the recess part, and thus, the coating film is hard to peel off.

### Means to Solve the Problem

In order to achieve the above-described first object, according to a first aspect of the invention, there is provided a leather punching device configured to form punch holes in a leather, wherein a punching device main body has a receiving mold formed with a plurality of receiving holes, a pressing mold that can be joined with the receiving mold and is formed with a plurality of storing holes each communicating with the plurality of receiving holes when joined with the receiving mold, and a moving member provided with a plurality of punching pins stored in the plurality of storing holes of the pressing mold, pressing projections are provided around the storing holes on a joint surface of the pressing mold, the leather punching device is configured so that when the moving member moves to one side, the plurality of punching pins projects from the pressing projections of the pressing mold, and when the moving member moves to the other side, the plurality of punching pins is retracted into the storing holes of the pressing mold, the leather is disposed between the receiving mold and the pressing mold, the pressing projections of the pressing mold are brought into pressure-contact with the leather, and the plurality of punching pins projects from the pressing projections of the pressing mold by movement of the moving member to one side to form the punch holes in the leather.

In order to achieve the above-described first object, in the leather punching device according to a second aspect of the invention, the pressing projections of the pressing mold are brought into pressure-contact with the leather to form recess parts, and the plurality of punching pins projects from the pressing projections of the pressing mold by movement of the moving member to one side to form the punch holes substantially at the centers of the recess parts formed in the leather.

In order to achieve the above-described first object, in the leather punching device according to a third aspect, surface processing for providing slippery surface is performed on the joint surface of the pressing mold.

In order to achieve the above-described first object, in the leather punching device according to a fourth aspect, the punching device main body is provided with heating means for heating the leather.

In order to achieve the second object, according to a sixth aspect of the invention, there is provided a leather punching method of forming punch holes in a leather, wherein a leather sheet is formed by a first process of disposing the leather in a receiving mold formed with a plurality of receiving holes, a second process of holding the leather by pressing projections of a pressing mold formed with a plurality of storing holes and having the pressing projections formed around the storing holes of a joint surface side and the receiving mold, and a third process of causing punching pins stored in the plurality of storing holes of the pressing mold to project to the receiving holes of the receiving mold from the pressing projections by the moving member, thereby forming the punch holes in the leather held by the receiving mold and the pressing projections of the pressing mold.

In order to achieve the second object, according to a seventh aspect of the invention, there is provided a leather punching method of forming punch holes in a leather, wherein a leather sheet is formed by a first process of disposing the leather in a receiving mold formed with a plurality of receiving holes, a second process of holding the leather by a pressing mold formed with a plurality of storing holes and having pressing projections formed around the storing holes of a joint surface side and the receiving mold, thereby forming recess parts on a front surface of the leather by the pressing projections, and a third process of causing punching pins stored in the plurality of storing holes of the pressing mold to project to the receiving holes of the receiving mold from the pressing projections by a moving member, thereby forming the punch holes substantially at the centers of each of the plurality of recess parts of the leather formed by being held by the receiving mold and the pressing mold.

In order to achieve the second object, according to an eighth aspect of the invention, there is provided a leather punching method of forming punch holes in a leather, wherein a leather sheet is formed by a first process of disposing the leather on a receiving mold formed with a plurality of receiving holes, a second process of heating the leather, a third process of holding the leather by pressing projections of a pressing mold formed with a plurality of storing holes and having the pressing projections formed around the storing holes of a joint surface side and the receiving mold, and a fourth process of causing punching pins stored in the plurality of storing holes of the pressing mold to project to the receiving holes of the receiving mold from the pressing projections by a moving member, thereby forming the punch holes in the leather while being held by the receiving mold and the pressing projections of the pressing mold.

In order to achieve the second object, according to a ninth aspect of the invention, there is provided a leather punching method of forming punch holes in a leather, wherein a leather sheet is formed by a first process of disposing the leather on a receiving mold formed with a plurality of receiving holes, a second process of heating the leather, a third process of holding the leather by a pressing mold formed with a plurality of storing holes and having pressing projections formed around the storing holes of a joint surface side and the receiving mold, thereby forming recess parts on a front surface of the leather by the pressing projections, and a fourth process of causing punching pins stored in the plurality of storing holes of the pressing mold to project to the receiving holes of the receiving mold from the pressing projections by a moving member, thereby forming the punch holes substantially at the centers of each of the plurality of recess parts of the leather formed by being held by the receiving mold and the pressing mold.

In order to achieve the third object, a leather sheet according to fifth, tenth or eleventh aspects of the invention is made up of a leather, recess parts formed by being pressed on a front surface side of the leather, and punch holes formed through the leather substantially at the centers of the recess parts.

### Effect of the Invention

The leather punching device according to the invention is a leather punching device configured to form punch holes in a leather, in which a punching device main body has a receiving mold formed with a plurality of receiving holes, a pressing mold that can be joined with the receiving mold and is formed with a plurality of storing holes each communicating with the plurality of receiving holes when joined with the receiving mold, and a moving member provided with a plurality of punching pins stored in the plurality of storing holes of the pressing mold, pressing projections are provided around the storing holes on a joint surface of the pressing mold, the leather punching device is configured so that when the moving member moves to one side, the plurality of punching pins projects from the pressing projections of the pressing mold, and when the moving member moves to the other side, the plurality of punching pins is retracted into the storing holes of the pressing mold, the leather is disposed between the receiving mold and the pressing mold, the pressing projections of the pressing mold are brought into pressure-contact with the leather, and the plurality of punching pins projects from the pressing projections of the pressing mold by movement of the moving member to one side to form the punch holes in the leather.

The leather punching device according to the invention is configured so that when the leather is disposed between the receiving mold and the pressing mold, and the pressing mold is brought into pressure-contact with the receiving mold, the pressing projections press the periphery of the position where the leather is to be punched. The plurality of punching pins projects from the pressing projections of the pressing mold by movement of the moving member to one side to form the punch holes in the leather. In the leather punching device according to the invention, when punching and drawing out the punching pins, since the pressing projections of the pressing mold hold and press the leather on the periphery of the punching position, there is an effect in which the leather is not stretched, there is no fluffing, it is possible to smoothly insert and pull out the punching pins into and from the leather, and it is possible to form beautiful punch holes.

In the leather punching device according to the invention, the pressing projections of the pressing mold are brought into pressure-contact with the leather to form the recess parts, and the plurality of punching pins projects from the pressing projections of the pressing mold by movement of the moving member to one side to form the punch holes substantially at the centers of the recess parts formed in the leather.

The leather punching device according to the invention is configured so that when the leather is disposed between the receiving mold and the pressing mold, and the pressing mold is brought into pressure-contact with the receiving mold, the pressing projections press the periphery of the position where the leather is to be punched, thereby forming the recess parts. The plurality of punching pins projects from the pressing projections of the pressing mold by the movement of the moving member to one side, thereby forming the punch holes at the centers of the plurality of recess parts formed in the leather. In the leather punching device according to the invention, when punching and drawing out the punching pins, since the pressing projections of the pressing mold hold and press the leather on the periphery of the punching position, there is an effect in which the leather is not stretched, there is no fluffing, it is possible to smoothly insert and pull out the punching pins into and from the leather, and it is possible to form beautiful punch holes.

In the leather punching device according to the invention, since the surface processing for providing slippery surface is performed on the joint surface of the pressing mold, there is an effect in which the leather is not damaged, and it is possible to easily pull apart the joint surface of the pressing mold from the leather. In the leather punching device according to the invention, since the heating means for heating the leather is provided in the punching device main body, there is an effect in which it is possible to provide the flexible leather by heating and to make it easy to process the leather. Furthermore, there is an effect of curing the leather by heating and punching, and preventing the formed recess parts from returning to an initial state due to elasticity of the leather. Furthermore, since it is possible to form a uniform depth of the recess parts around the punch holes, there is an effect in which it is possible to form more beautiful punch holes as compared to the case where the leather is not heated.

Furthermore, in some cases, the joint surface and the front surface of leather may stick by heating the leather, but, as described above, there is an effect of preventing sticking by performing the surface processing for providing slippery surface on the joint surface.

The leather punching method according to the invention is a leather punching method of forming punch holes in a leather, in which the leather sheet is formed by a first process of disposing the leather in a receiving mold formed with a plurality of receiving holes, a second process of holding the leather by pressing projections of a pressing mold formed with a plurality of storing holes and having the pressing projections formed around the storing holes of a joint surface side and the receiving mold, and a third process of causing punching pins stored in the plurality of storing holes of the pressing mold to project to the receiving holes of the receiving mold from the pressing projections by a moving member, thereby forming the punch holes in the leather held by the receiving mold and the pressing projections of the pressing mold.

In the leather punching method according to the invention, when the leather is disposed between the receiving mold and the pressing mold, and the pressing mold is brought into pressure-contact with the receiving mold, the pressing projections press the periphery of the position where the leather is to be punched. The plurality of punching pins projects from the pressing projections of the pressing mold by the movement of the moving member to one side to form the punch holes in the leather. In the leather punching method according to the invention, when punching and drawing out the punching pins, since the pressing projections of the pressing mold hold and press the leather on the periphery of the punching position, there is an effect in which the leather is not stretched, there is no fluffing, it is possible to smoothly insert and pull out the punching pins into and from the leather, and it is possible to form beautiful punch holes.

The leather punching method according to the invention is a leather punching method of forming punch holes in a leather, in which a leather sheet is formed by a first process of disposing the leather in a receiving mold formed with a plurality of receiving holes, a second process of holding the leather by a pressing mold formed with a plurality of storing holes and having pressing projections formed around the storing holes of a joint surface side and the receiving mold, thereby forming recess parts on a front surface of the leather by the pressing projections, and a third process of causing punching pins stored in the plurality of storing holes of the pressing mold to project to the receiving holes of the receiving mold from the pressing projections by a moving member, thereby forming the punch holes substantially at the centers of each of the plurality of recess parts of the leather formed by being held by the receiving mold and the pressing mold.

In the leather punching method according to the invention, when the leather is disposed between the receiving mold and the pressing mold, and the pressing mold is brought into pressure-contact with the receiving mold, the pressing projections press the periphery of the position where the leather is to be punched, thereby forming the recess parts. The plurality of punching pins projects from the pressing projections of the pressing mold by the movement of the moving member to one side, thereby forming the punch holes at the centers of the plurality of recess parts formed in the leather. In the leather punching method according to the invention, when punching and drawing out the punching pins, since the pressing projections of the pressing mold hold and press the leather on the periphery of the punching position, there is an effect in which the leather is not stretched, there is no fluffing, it is possible to smoothly insert and pull out the punching pins into and from the leather, and it is possible to form beautiful punch holes.

The leather punching method according to the invention is a leather punching method of forming punch holes in a leather, in which a leather sheet is formed by a first process of disposing the leather on a receiving mold formed with a plurality of receiving holes, a second process of heating the leather, a third process of holding the leather by pressing projections of a pressing mold formed with a plurality of storing holes and having the pressing projections formed around the storing holes of a joint surface side and the receiving mold, and a fourth process of causing punching pins stored in the plurality of storing holes of the pressing mold to project to the receiving holes of the receiving mold from the pressing projections by a moving member, thereby forming the punch holes in the leather while being held by the receiving mold and the pressing projections of the pressing mold.

In the leather punching method according to the invention, when the leather is disposed between the receiving mold and the pressing mold, the leather is heated, and the pressing mold is brought into pressure-contact with the receiving mold, the pressing projections press the periphery of the position where the leather is to be punched. The plurality of punching pins projects from the pressing projections of the pressing mold by the movement of the moving member to one side to form the punch holes in the leather. In the leather punching method according to the invention, when punching and drawing out the punching pins, since the pressing projections of the pressing mold hold and press the leather on the periphery of the punching position, there is an effect in which the leather is not stretched, there is no fluffing, it is possible to smoothly insert and pull out the punching pins into and from the leather, and it is possible to form beautiful punch holes. Furthermore, in the leather punching method according to the invention, since the leather is heated before processing, the leather is softened, and it is extremely easy to form the punch holes.

The leather punching method according to the invention is a leather punching method of forming punch holes in a leather, in which a leather sheet is formed by a first process of disposing the leather on a receiving mold formed with a plurality of receiving holes, a second process of heating the leather, a third process of holding the leather by the pressing mold formed with a plurality of receiving holes and having pressing projections formed around the storing holes of a joint surface side and the receiving mold, thereby forming recess parts on the front surface of the leather by the pressing projections, and a fourth process of causing punching pins stored in the plurality of storing holes of the pressing mold to project to the receiving holes of the receiving mold from the pressing projections by a moving member, thereby forming the punch holes substantially at the centers of each of the plurality of recess parts of the leather formed by being held by the receiving mold and the pressing mold.

In the leather punching method according to the invention, when the leather is disposed between the receiving mold and the pressing mold, the leather is heated, and the pressing mold is brought into pressure-contact with the receiving mold, the pressing projections press the periphery of the position where the leather is to be punched, thereby forming the recess parts. The plurality of punching pins projects from the pressing projections of the pressing mold by the movement of the moving member to one side to form the punch holes at the center of the plurality of recess parts formed in the leather. In the leather punching method according to the invention, when punching and drawing out the punching pins, since the pressing projections of the pressing mold hold and press the leather on the periphery of the punching position, there is an effect in which the leather is not stretched, there is no fluffing, it is possible to smoothly insert and pull out the punching pins into and from the leather, and it is possible to form beautiful punch holes. Furthermore, in the leather punching method according to the invention, since the leather is heated before processing, there is an effect in which the leather is softened, and it is extremely easy to form the recess parts and the punch holes.

The leather sheet according to the invention includes the leather, the recess parts formed by being pressed on the front surface side of the leather, and the punch holes formed through the leather substantially at the centers of the recess parts. Since the leather sheet according to the invention is configured so that the peripheries of the punch holes are positioned at the bottoms of the recess parts, as compared to the conventional punch holes positioned on the front surface, a risk of contact with the peripheries of the punch holes is very low, and thus, there is an effect in which a structure in which a coating film is hard to peel off is provided.

### BRIEF DESCRIPTION OF DRAWINGS

FIG. 1 is an overall front view of a leather punching device according to the invention.

FIG. 2 is a perspective view of a pressing mold of the leather punching device according to the invention.

FIG. 3 is an overall front view when joining the pressing mold and the receiving mold of the leather punching device of FIG. 1.

FIG. 4 is an overall front view when punching the punching pins of the leather punching device of FIG. 1.

FIG. 5 is an overall front view when pulling out the punching pins of the leather punching device of FIG. 1.

FIG. 6 is an overall front view after completion of punching of the leather punching device of FIG. 1.

FIG. 7 is a cross-sectional view of a leather in which punch holes are formed.

FIG. 8 is a perspective view of the leather in which the punch holes are formed.

FIG. 9 is an overall front view of a conventional leather punching device.

FIG. 10 is an overall front view when joining the pressing mold and the receiving mold of the leather punching device of FIG. 9.

FIG. 11 is an overall front view when punching the punching pin of the leather punching device of FIG. 9.

FIG. 12 is an overall front view after completion of punching of the leather punching device of FIG. 9.

FIG. 13 is a cross-sectional view of a leather in which the punch holes are formed by the leather punching device of FIG. 9.

FIG. 14 is a front view illustrating a front surface of a leather sheet according to the invention.

FIG. 15 is a rear view illustrating a back surface of the leather sheet according to the invention.

FIG. 16 is a front view illustrating a front surface of a conventional leather sheet.

FIG. 17 is a rear view illustrating a back surface of the conventional leather sheet.

### BEST MODE FOR CARRYING OUT OF THE INVENTION

A leather punching device 1 is a leather punching device that forms punch holes 9 in a leather 3. As illustrated in FIG. 1, a punching device main body 1A has a receiving mold 21 formed with a plurality of receiving holes 22, a pressing mold 31 that can be joined with the receiving mold 21 and is formed with a plurality of storing holes 32 each communicating with the plurality of receiving holes 22 when joined with the receiving mold 21, and a moving member 45 provided with a plurality of punching pins 5 stored in the plurality of storing holes 32 of the pressing mold 31. Pressing projections 35 are provided around the storing holes 32 on a joint surface 33 of the pressing mold 31. The leather punching device 1 is configured so that when the moving member 45 moves to one side (downward), the plurality of punching pins 5 projects from the pressing projections 35 of the pressing mold 31, and when the moving member 45 moves to the other side (upward), the plurality of punching pins 5 is retracted into the storing holes 32 of the pressing mold 31. As illustrated in FIG. 3, the leather punching device 1 is configured so that the leather 3 is disposed between the receiving mold 21 and the pressing mold 31, the pressing projections 35 of the pressing mold 31 are brought into pressure-contact with the leather 3, and as illustrated in FIG. 4, the plurality of punching pins 5 projects from the pressing projections 35 of the pressing mold 31 by the movement of the moving member 45 to one side to form the punch holes 9 in the leather 3.

The leather punching device 1 is configured so that when the leather 3 is disposed between the receiving mold 21 and the pressing mold 31, and the pressing mold 31 is brought into pressure-contact with the receiving mold 21, the pressing projections 35 press the periphery of the position where the leather 3 is to be punched. The plurality of punching pins 5 projects from the pressing projections 35 of the pressing mold 31 by movement of the moving member 45 to one side to form the punch holes 9 in the leather 3. In this way, the leather punching device 1 can form a leather sheet S. Furthermore, in the leather punching device 1, when punching and drawing out the punching pins 5, since the pressing projections 35 of the pressing mold 31 hold and press the leather 3 on the periphery of the punching position, the leather 3 is not stretched, there is no fluffing, it is possible to smoothly insert and pull out the punching pins 5 into and from the leather 3, and it is possible to form beautiful punch holes 9.

As illustrated in FIG. 3, the leather punching device 1 is configured so that the leather 3 is disposed between the receiving mold 21 and the pressing mold 31, the pressing projections 35 of the pressing mold 31 are brought into pressure-contact with the leather 3 to form recess parts 3C, and as illustrated in FIG. 4, the plurality of punching pins 5 projects from the pressing projections 35 of the pressing mold 31 by the movement of the moving member 45 to one side, thereby forming the punch holes 9 substantially at the centers of the recess parts 3C formed on the leather 3.

That is, the leather punching device 1 is configured so that when the leather 3 is disposed between the receiving mold 21 and the pressing mold 31, and the pressing mold 31 is brought into pressure-contact with the receiving mold 21, the pressing projections 35 press the periphery of the position where the leather 3 is to be punched, thereby forming the recess parts 3C. The plurality of punching pins 5 projects from the pressing projections 35 of the pressing mold 31 by movement of the moving member 45 to one side, thereby forming the punch holes 9 at the centers of the plurality of recess parts 3C formed in the leather 3. In this way, the leather punching device 1 can form the leather sheet S. Furthermore, in the leather punching device 1, when punching and drawing out the punching pins 5, since the pressing projections 35 of the pressing mold 31 hold and press the leather 3 on the periphery of the punching position, the leather 3 is not stretched, there is no fluffing, it is possible to smoothly insert and pull out the punching pins 5 into and from the leather 3, and it is possible to form beautiful punch holes 9.

Since the leather punching device 1 is configured so that surface processing for providing slippery surface is performed on a joint surface 33 of the pressing mold 31, the leather 3 is not damaged, and it is possible to easily pull apart the joint surface 33 of the pressing mold 31 from the leather 3. Furthermore, since the leather punching device 1 is configured so that a heating means 25 for heating the leather 3 is provided in the punching device main body 1A, it is possible to provide the flexible leather 3 by heating and to easily process the leather 3. Furthermore, the leather 3 is cured by heating and punching, and the formed recess parts 3C are prevented from returning to an initial state due to elasticity of the leather 3. Furthermore, since it is possible to form a uniform depth of the recess parts 3C around the punch holes 9, it is possible to form more beautiful punch holes 9 as compared to the case where the leather 3 is not heated. Furthermore, in some cases, the joint surface 33 and the front surface 3D of the leather 3 may be stuck by heating the leather 3, but, as described above, the sticking is prevented by performing the surface processing for providing slippery surface on the joint surface 33.

The leather punching method is a method of forming the punch holes 9 in the leather 3. The leather punching method forms the leather sheet S by a first process of disposing the leather 3 in the receiving mold 21 formed with the plurality of receiving holes 22, a second process of holding the leather 3 by the pressing projections 35 of the pressing mold 31 formed with the plurality of storing holes 32 and having the pressing projections 35 formed around the storing holes 32 of the joint surface 33 side and the receiving mold 21, and a third process of causing the punching pins 5 stored in the plurality of storing holes 32 of the pressing mold 31 to project to the receiving holes 22 of the receiving mold 21 from the pressing projections 35 by the moving member 45, thereby forming the punch holes 9 in the leather 3 held by the receiving mold 21 and the pressing projections 35 of the pressing mold 31.

In the above-described leather punching method, when the leather 3 is disposed between the receiving mold 21 and the pressing mold 31, and the pressing mold 31 is brought into pressure-contact with the receiving mold 21, the pressing projections 35 press the periphery of the position where the leather 3 is to be punched. In the leather punching method, the plurality of punching pins 5 projects from the pressing projections 35 of the pressing mold 31 by movement of the moving member 45 to one side, thereby forming the punch holes 9 in the leather 3. In this way, the leather punching method can form the leather sheet S. Furthermore, in the leather punching method, when punching and drawing out the punching pins 5, since the pressing projections 35 of the pressing mold 31 hold and press the leather 3 on the periphery of the punching position, the leather 3 is not stretched, there is no fluffing, it is possible to smoothly insert and pull out the punching pins 5 into and from the leather 3, and it is possible to form beautiful punch holes 9.

The leather punching method is a method of forming the punch holes 9 in the leather 3. The leather punching method forms the leather sheet S by a first process of disposing the leather 3 in the receiving mold 21 formed with the plurality of receiving holes 22, a second process of holding the leather 3 by the pressing mold 31 formed with the plurality of storing holes 32 and having the pressing projections 35 formed around the storing holes 32 of the joint surface 33 side and the receiving mold 21, thereby forming the recess parts 3C on the front surface 3D of the leather 3 by the pressing projections 35, and a third process of causing the punching pins 5 stored in the plurality of storing holes 32 of the pressing mold 31 to project to the receiving holes 22 of the receiving mold 21 from the pressing projections 35 by the moving member 45, thereby forming the punch holes 9 substantially at the centers of each of the plurality of recess parts 3C of the leather 3 formed by being held by the receiving mold 21 and the pressing mold 31.

In the above-described leather punching method, when the leather 3 is disposed between the receiving mold 21 and the pressing mold 31, and the pressing mold 31 is brought into pressure-contact with the receiving mold 21, the pressing projections 35 press the periphery of the position where the leather 3 is to be punched, thereby forming the recess parts 3C. In the leather punching method, the plurality of punching pins 5 projects from the pressing projections 35 of the pressing mold 31 by movement of the moving member 45 to one side, thereby forming the punch holes 9 at the centers of the plurality of recess parts 3C formed in the leather 3. Thus, the leather punching method can form the leather sheet S. Furthermore, in the leather punching method, when punching and drawing out the punching pins 5, since the pressing projections 35 of the pressing mold 31 hold and press the leather 3 on the periphery of the punching position, the leather 3 is not stretched, there is no fluffing, it is possible to smoothly insert and pull out the punching pins 5 into and from the leather 3, and it is possible to form beautiful punch holes 9.

Furthermore, the leather punching method including the heating process forms the leather sheet S by a first process of disposing the leather 3 on the receiving mold 21 formed with the plurality of receiving holes 22, a second process of heating the leather 3, a third process of holding the leather 3 by the pressing projections 35 of the pressing mold 31 formed with the plurality of storing holes 32 and having the pressing projections 35 formed around the storing holes 32 of the joint surface 33 side and the receiving mold 21, and a fourth process of causing the punching pins 5 stored in the plurality of storing holes 32 of the pressing mold 31 to project to the receiving holes 22 of the receiving mold 21 from the pressing projections 35 by the moving member 45, thereby forming the punch holes 9 in the leather 3 held by the receiving mold 21 and the pressing projections 35 of the pressing mold 31.

In the leather punching method, when the leather 3 is disposed between the receiving mold 21 and the pressing mold 31, the leather 3 is heated, and the pressing mold 31 is brought into pressure-contact with the receiving mold 21, the pressing projections 35 press the periphery of the position where the leather 3 is to be punched. In the leather punching method, the plurality of punching pins 5 projects from the pressing projections 35 of the pressing mold 31 by movement of the moving member 45 to one side, thereby forming the punch holes 9 in the leather 3. Thus, the leather punching method can form the leather sheet S. Furthermore, in the leather punching method, when punching and drawing out the punching pins 5, since the pressing projections 35 of the pressing mold 31 hold and press the leather 3 on the periphery of the punching position, the leather 3 is not stretched, there is no fluffing, it is possible to smoothly insert and pull out the punching pins 5 into and from the leather 3, and it is possible to form beautiful punch holes 9.

Furthermore, the leather punching method including the heating process forms the leather sheet S by a first process of disposing the leather 3 on the receiving mold 21 formed with the plurality of receiving holes 22, a second process of heating the leather 3, a third process of holding the leather 3 by the pressing mold 31 formed with the plurality of storing holes 32 and having the pressing projections 35 formed around the storing holes 32 of the joint surface 33 side and the receiving mold 21, thereby forming the recess parts 3C on the front surface 3D of the leather 3 by the pressing projections 35, and a fourth process of causing the punching pins 5 stored in the plurality of storing holes 32 of the pressing mold 31 to project to the receiving holes 22 of the receiving mold 21 from the pressing projections 35 by the moving member 45, thereby forming the punch holes 9 substantially at the centers of each of the plurality of recess parts 3C of the leather 3 formed by being held by the receiving mold 21 and the pressing mold 31.

In the leather punching method, when the leather 3 is disposed between the receiving mold 21 and the pressing mold 31, the leather 3 is heated, and the pressing mold 31 is brought into pressure-contact with the receiving mold 21, the pressing projections 35 press the periphery of the position where the leather 3 is to be punched to form the recess parts 3C. In the leather punching method, the plurality of punching pins 5 projects from the pressing projections 35 of the pressing mold 31 by the movement of the moving member 45 to one side, thereby forming the punch holes 9 at the centers of the plurality of recess parts 3C formed in the leather 3. Thus, the leather punching method can form the leather sheet S. Furthermore, in the leather punching method, when punching and drawing out the punching pins 5, since the pressing projections 35 of the pressing mold 31 hold and press the leather 3 on the periphery of the punching position, the leather 3 is not stretched, there is no fluffing, it is possible to smoothly insert and pull out the punching pins 5 into and from the leather 3, and it is possible to form beautiful punch holes 9. Furthermore, since the leather punching method heats the leather 3 before processing, the leather 3 is softened, and it is extremely easy to form the recess parts 3C and the punch holes 9.

As illustrated in FIGS. 7 and 8, the leather sheet S includes the leather 3, the recess parts 3C formed by being pressed on the front surface 3D side of the leather 3, and the punch holes 9 formed through the leather 3 substantially at the centers of the recess parts 3C. Since the leather sheet S is configured so that peripheries 9a of the punch holes 9 are positioned at the bottoms 3E of the recess parts 3C, a risk of contacting with the peripheries 9a of the punch holes 9 is very low as compared to the conventional punch holes 9 positioned on the front surface 3D, and thus, a structure in which the coating film 3F is hard to peel off is obtained.

Furthermore, the leather punching device 1 will be described in detail. As illustrated in FIG. 1, the leather punching device 1 has a base 2, and a pressing device 10 provided on the base 2. The pressing device 10 is provided with a pressing shaft 11 that moves towards a vertical direction. The pressing shaft 11 is a drive shaft which is actuated by a drive device such as a hydraulic cylinder, a pneumatic cylinder, and an electromagnetic actuator. A punching device 30 is provided on a front end of the pressing shaft 11.

The receiving mold 21 is mounted onto the base 2 by being fixed by bolts or the like. The receiving mold 21 is formed with the plurality of receiving holes 22. The punching device 30 has a fixing member 41 to which the pressing mold 31 is mounted by being fixed by bolts or the like. The pressing mold 31 can be joined with the receiving mold 21 and is formed with a plurality of storing holes 32 each communicating with the plurality of receiving holes 22 when joined with the receiving mold 21.

As illustrated in FIG. 2, at the position of the storing holes 32 on the joint surface 33 of the pressing mold 31, the pressing projections 35 of inverted truncated cone shape are formed. The pressing projections 35 include an upper circular base 36, a lower circular pressing surface 38, and an inclined surface 37 that obliquely descends so that an outer diameter thereof becomes smaller toward the periphery of the circular pressing surface 38 from the circular base 36. The storing holes 32 are provided substantially at the centers of the pressing projections 35, and the punching pins 5 appear and disappear from substantially the center of the circular pressing surface 38. The pressing projections 35 are formed so that a diameter D1 of the circular base 36 is approximately 2.3 mm, a diameter D2 of the circular pressing surface 38 is approximately 1.5 mm, and a height H is approximately 0.8 mm with respect to the leather 3 having a wall thickness of 1.2 mm, an inner diameter D3 of the storing holes 32 for storing the punching pins 5 formed substantially at the center is approximately 1.3 mm, and an inclined angle α of the inclined surface 37 is approximately 20°. In addition, it is a matter of course that the pressing projections 35 are not limited to this embodiment and can be suitably changed by the type, the thickness, the recess part shape, or the like of the leather 3. In addition, lubricant such as silicone resin and fluorine resin is applied onto the joint surface 33 of the pressing mold 31.

The fixing member 41 is formed with insertion holes 42 through which the punching pins 5 stored in the storing holes 32 of the pressing mold 31 are inserted. The punching pins 5 include a perforation pin 6 and a head 7 formed at a rear end of the perforation pin 6. Rear parts of the punching pins 5 are attached to the moving member 45.

The moving member 45 includes a mounting plate 46 and a cover plate 47, and is formed by the mounting plate 46 and the cover plate 47 being superimposed and fixed by bolts or the like. The mounting plate 46 is formed with insertion holes 48 through which the perforation pins 6 of the punching pins 5 are inserted, and engaging recess parts 49 configured to engage the heads 7 of the punching pins 5 are formed on the upper surface side of the insertion holes 48. The punching pins 5 are fixed to the moving member 45 by inserting the perforation pins 6 into the insertion holes 48 of the mounting plate 46, engaging the heads 7 with the engaging recess parts 49 of the mounting plate 46, and fixing the cover plate 47 to the upper surface of the mounting plate 46 by bolts or the like.

The moving member 45 and the fixing member 41 are connected with each other by a connecting shaft 51. The connecting shaft 51 is slidably inserted into a connecting hole 45a formed in the moving member 45 and a connecting hole 41a formed in the fixing member 41. Both ends of the connecting shaft 51 are formed so as to be engaged with a stepped portion 45b of the moving member 45 and a stepped portion 41d of the fixing member 41. A spring member (elastic member) 52 is wound around the connecting shaft 51.

The spring members 52 (elastic member) abuts against the lower surface 45c of the moving member 45 at an upper end, and abuts against the upper surface 41c of the fixing member 41 at a lower end to urge the moving member 45 and the fixing member 41 in directions away from each other, and the stepped portion 45b of the moving member 45 and the stepped portion 41d of the fixing member 41 are engaged with both ends of the connecting shaft 51. In this state, the front ends 8 of the punching pins 5 are retracted into the storing holes 32 of the pressing mold 31. The moving member 45 is fixed to the front end of the pressing shaft 11 of the pressing device 10.

The moving member 45 is formed with a guide hole 53. Furthermore, the fixing member 41 is formed with a guide hole 43. Guide shafts 4 and 4 are provided on the upper surface of the base 2. The moving member 45 and the fixing member 41 are configured so that the guide holes 53 and 43 are guided by the guide shafts 4 and 4, and pressing mold 31 is accurately joined with the receiving mold 21 without shifting.

The leather punching device 1 is provided with the heating means 25 for heating the leather 3 mounted on the receiving mold 21. As the heating means 25, there is a dryer for warming the leather 3 by blowing hot air, a superheated steam generator for warming the leather 3 by blowing superheated steam, a power supply device for causing current to directly flow through the pressing mold 31 to warm the leather 3. The heating means 25 is mounted to the upper surface 2a of the base 2. The heating temperature can be changed depending on the type of leather, but the leather may be heated at a temperature at which the coating film of the leather surface is not dissolved out, or at a temperature at which chromium in the leather sheet does not shrink, and a range of about 50° C. to 80° C. is desirable.

The leather punching device 1 has the above-described configuration and can be used as below. As illustrated in FIG. 1, since the moving member 45 and the fixing member 41 are spaced apart by the spring member 52 (elastic member), the punching pins 5 is configured so that the front ends 8 of the perforation pins 6 are stored in the storing holes 32 of the pressing mold 31. The leather 3 is placed on the receiving mold 21.

As illustrated in FIG. 3, when the pressing device 10 is driven to move the pressing shaft 11 downward, the punching device 30 also moves downward and the pressing projections 35 of the pressing mold 31 come into pressure-contact with the receiving mold 21 while holding the leather 3 therebetween. The periphery of the punching position of the leather 3 is pressed by the pressing projections 35. In some cases, the leather 3 may be formed with recess parts 3C of inverted truncated cone shape by the pressing projections 35. The fixing member 41 stops the movement in this state, but the moving member 45 moves downward against elasticity of the spring member (elastic member) 52, as illustrated in FIG. 4, a gap between the fixing member 41 and the moving member 45 becomes narrower, and the perforation pins 6 of the punching pins 5 project from the interior of the storing holes 32 of the pressing mold 31, that is, from the pressing projections 35.

The perforation pins 6 projecting from the pressing projections 35 of the first pressing mold 31 punch the leather 3 to form the punch holes 9, and are inserted into the receiving hole 22 of the receiving mold 21. When the recess parts 3C are formed in the leather 3, the punch holes 9 are formed by performing the punching from the centers of the bottoms 3E of the recess parts 3C of the leather 3, and are inserted into the receiving holes 22 of the receiving mold 21. Since the peripheries of the perforation pins 6 are pressed by the pressing projections 35 during punching, the upper end portion (a front surface side of the grain side layer 3A or a front surface side of the reticular layer 3B) of the leather 3 is not pulled to the inside lower part of the punch holes 9. Furthermore, since the reticular layer 3B is also compressed by the pressing projections 35, the fiber is rarely drawn.

As illustrated in FIG. 5, when pulling the pressing shaft 11 upward, in a state in which the pressing projections 35 of the pressing mold 31 come into pressure-contact with the receiving mold 21 while holding the leather 3 therebetween, the moving member 45 moves upward, and the gap between the fixing member 41 and the moving member 45 spreads, and the perforation pins 6 of the punching pins 5 are stored in the storing holes 32 of the pressing mold 31. When pulling out the punching pins 5, the leather 3 of the peripheries of the perforation pins 6 is pressed by the pressing projections 35, as illustrated in FIGS. 7, 14 and 15, the upper end portion (the front surface side of the grain side layer 3A or the front surface side of the reticular layer 3B) is not pulled to the inside upper part of the punch holes 9. Furthermore, since the reticular layer 3B is also compressed by the pressing projections 35, the fiber 3G is rarely drawn. Furthermore, as illustrated in FIG. 6, when the pressing shaft 11 is pulled upward, the pressing mold 31 is separated from the receiving mold 21 and returns to the initial state. Since lubricant such as silicone resin and fluorine resin is applied to the joint surface 33 of the pressing mold 31, the pressing mold can be easily separated from the leather 3 and does not damage the leather 3.

In this way, it is possible to take out the leather sheet S in which the punch holes 9 are formed on the bottoms 3E of the recess parts 3C of the leather 3. As illustrated in FIG. 7, the punch holes 9 of the leather sheet S have a configuration formed at the centers of the bottoms 3E of the recess parts 3C. In order to impart protection, aesthetic, and function primarily to the front surface of the leather 3, paint is applied to the front surface, and the coating film 3F is formed. The coating film 3F is easily peeled off from the end edge. In the punch holes of the conventional leather 3, since the punch hole peripheries (end edges) are at the same position as the front surface of the leather 3, finger nails or the like easily come into contact with the punch hole peripheries (end edges), and the coating film 3F is easily peeled off. However, the punch holes 9 of the leather sheet S have a configuration formed on the centers of the bottoms 3E of the recess parts 3C. It is hard to come into contact with the coating film 3F pressed to the bottoms 3E of the recess parts 3C, compared to the case of forming the punch holes in the conventional leather 3 as illustrated in FIG. 13, and the coating film is rarely peeled off from the peripheries of the punch holes 9. In addition, the depth of the recess parts 3C is about 0.2 to 0.3 mm.

Furthermore, in this embodiment, the leather 3 is a leather having the grain side layer 3A and the reticular layer 3B, but the leather 3 may be a leather that is made up of only the reticular layer called a split leather. Further, the leather 3 is not intended to be particularly limited but may be a natural leather, a synthetic leather or the like. Furthermore, in the conventional leather punching device and leather punching method, in some cases, when inserting and pulling out the punching pins 5, as illustrated in FIGS. 16 and 17, the shape of the punch holes 9 is impaired by frictional resistance between the punching pins 5 and the leather 3, the fiber 3G of the reticular layer 3B is fluffed by being pulled into the punch holes 9, thereby blocking the punch holes 9. However, according to the leather punching device 1 and the leather punching method described above, since the leather 3 is to be punched with the periphery of the punching position being fixed, as illustrated in FIGS. 14 and 15, the shape of the punch holes 9 is not impaired, it is possible to prevent the fiber 3G of the reticular layer 3B from being fluffed by being pulled out into the punch holes 9, and it is possible to form very beautiful punch holes 9. Furthermore, the recess parts 3C are formed in an inverted truncated cone shape, but this shape is formed according to the shape of the pressing projections 35, it is, of course, possible to variously change the shape of the recess parts by changing the shape of the pressing projections 35, and the recess parts can also be formed in a polygonal shape such as a square and a hexagon.

### INDUSTRIAL APPLICABILITY

The invention is applicable to a leather punching device that performs the punch hole processing in the leather.

### REFERENCE SIGNS LIST

S leather sheet
1 leather punching device
1A punching device main body
2 base
2a upper surface
3 leather
3A grain side layer
3B reticular layer
3C recess part
3D front surface
3E bottom
3F coating film
3G fiber
4 guide shaft
5 punching pin
6 perforation pin
7 head
8 front end
9 punch hole
9a periphery
10 pressing device
11 pressing shaft
21 receiving mold
22 receiving hole
25 heating means
30 punching device
31 pressing mold
32 storing hole
33 joint surface
35 pressing projection
36 circular base
37 inclined surface
38 circular pressing surface
41 fixing member
41a connecting hole
41c upper surface
41d stepped portion
42 insertion hole
43 guide hole
45 moving member
45a connecting hole
45b stepped portion
45c lower surface
46 mounting plate
47 cover plate
48 insertion hole
49 engaging recess part
51 connecting shaft
52 spring member (elastic member)
53 guide hole

1. A leather punching device for forming punch holes in a leather, the leather punching device comprising:
a receiving mold formed with a plurality of receiving holes;
a pressing mold that can be joined with the receiving mold, wherein the pressing mold is formed with a plurality of storing holes each communicating with the plurality of receiving holes when joined with the receiving mold; and
a moving member provided with a plurality of punching pins stored in the plurality of storing holes of the pressing mold,
wherein pressing projections are provided around the storing holes on a joint surface of the pressing mold,
wherein the leather punching device is configured so that the plurality of punching pins projects from the pressing projections of the pressing mold when the moving member moves to one side, and the plurality of punching pins is retracted into the storing holes of the pressing mold when the moving member moves to the other side, and
wherein the leather is disposed between the receiving mold and the pressing mold, the pressing projections of the pressing mold are brought into pressure-contact with the leather, the plurality of punching pins projects from the pressing projections of the pressing mold by the movement of the moving member to one side, and the punch holes are formed in the leather.

2. The leather punching device according to claim 1, wherein the pressing projections of the pressing mold are brought into pressure-contact with the leather to form recess parts, and the plurality of punching pins projects from the pressing projections of the pressing mold by the movement of the moving member to one side to form the punch holes substantially at the centers of the recess parts formed in the leather.

3. The leather punching device according to claim 1, wherein a surface of the pressing mold is performed surface processing for providing a slippery surface.

4. The leather punching device according to claim 1, wherein the punching device is provided with heating means for heating the leather.

5. A leather sheet formed by the leather punching device according to claim 1, comprising:
a leather;
recess parts formed on a front surface side of the leather by being pressed; and
punch holes formed through the leather substantially at the centers of the recess parts.

6. A leather punching method for forming punch holes in a leather, the method comprising:
disposing the leather in a receiving mold formed with a plurality of receiving holes;
holding the leather by pressing projections of a pressing mold formed with a plurality of storing holes and having the pressing projections formed around the storing holes of a joint surface side and the receiving mold; and
causing punching pins stored in the plurality of storing holes of the pressing mold to project to the receiving holes of the receiving mold from the pressing projections by a moving member, thereby forming the punch holes in the leather held by the receiving mold and the pressing projections of the pressing mold.

7. A leather punching method of forming punch holes in a leather, wherein a leather sheet is formed by a method comprising:
disposing the leather in a receiving mold formed with a plurality of receiving holes;
holding the leather by a pressing mold formed with a plurality of storing holes and having pressing projections formed around the storing holes of a joint surface side and the receiving mold, thereby forming recess parts on a front surface of the leather by the pressing projections; and
causing punching pins stored in the plurality of storing holes of the pressing mold to project to the receiving holes of the receiving mold from the pressing projections by a moving member, thereby forming the punch holes substantially at the centers of each of the plurality of recess parts of the leather formed by being held by the receiving mold and the pressing mold.

8. A leather punching method of forming punch holes in a leather, wherein a leather sheet is formed by a method comprising:
disposing the leather on a receiving mold formed with a plurality of receiving holes;
heating the leather;
holding the leather by pressing projections of a pressing mold formed with a plurality of storing holes and having the pressing projections formed around the storing holes of a joint surface side and the receiving mold; and
causing punching pins stored in the plurality of storing holes of the pressing mold to project to the receiving holes of the receiving mold from the pressing projections by a moving member, thereby forming the punch holes in the leather held by the receiving mold and the pressing projections of the pressing mold.

9. A leather punching method of forming punch holes in a leather, wherein a leather sheet is formed by a method comprising:
disposing the leather on a receiving mold formed with a plurality of receiving holes;
heating the leather;
holding the leather by a pressing mold formed with a plurality of storing holes and having pressing projections formed around the storing holes of a joint surface side and the receiving mold, thereby forming recess parts on a front surface of the leather by the pressing projections; and
causing punching pins stored in the plurality of storing holes of the pressing mold to project to the receiving holes of the receiving mold from the pressing projections by a moving member, thereby forming the punch holes substantially at the centers of each of the plurality of recess parts of the leather formed by being held by the receiving mold and the pressing mold.

10. A leather sheet formed by the leather punching method according to claim 6, comprising:
a leather;
recess parts formed by being pressed on a front surface side of the leather; and
punch holes formed through the leather substantially at the centers of the recess parts.

11. A leather sheet comprising:
a leather;
recess parts formed by being pressed on a front surface side of the leather; and
punch holes formed through the leather substantially at the centers of the recess parts.
